(19) United States
(12) Patent Application Publication
(10) Pub. No.: US 2019/0016586 A1
(43) Pub. Date: Jan. 17, 2019

(54) TRANSMISSION FLUID NOZZLE

(71) Applicant: FORD MOTOR COMPANY, Dearborn, MI (US)

(72) Inventors: Dengfu ZHANG, Northville, MI (US); Dongmin LI, Northville, MI (US); Vignesh SURESH, Ann Arbor, MI (US); Chin-Yuan PERNG, Ann Arbor, MI (US)

(21) Appl. No.: 15/647,359

(22) Filed: Jul. 12, 2017

(51) Int. Cl. B67D 7/42; B67D 7/46; G05D 9/12

(52) U.S. Cl. CPC B67D 7/42; G01F 23/00; G05D 9/12; B67D 7/465

(57) ABSTRACT

An apparatus is provided. The apparatus may include an elongated shaft including a passage terminating at a nozzle including a dispersion plate and tapered sidewalls between the dispersion plate and the elongated shaft. The tapered side walls may define a single opening, an outer surface of the sidewalls may define a tapered exit for the opening, an inner surface of the sidewalls may define a non-tapered entrance into the opening, the nozzle is sized to be received by a transmission case inlet, and an internal diameter of the passage is less than the tapered exit.

### TECHNICAL FIELD

This disclosure pertains to apparatuses for filling vehicle transmissions with transmission fluid.

### BACKGROUND

Transmissions may need to be filled with a specified quantity of fluid before they are sealed and shipped to a final assembly plant. Transmissions may require a significant amount of fluid, ranging between six quarts and 15 quarts, in a relatively short period of time. The fluid may be stored within a holding tank and pumped through a hose and a nozzle during the assembly process. The quantity of fluid and the short cycle time required to fill the transmission may lead to leaks or spills during the filling process.

### SUMMARY

According to one embodiment of this disclosure, an apparatus is provided. The apparatus may include an elongated shaft including a passage terminating at a nozzle including a dispersion plate and tapered sidewalls between the dispersion plate and the elongated shaft. The tapered side walls may define a single opening, an outer surface of the sidewalls may define a tapered exit for the opening, an inner surface of the sidewalls may define a non-tapered entrance into the opening, the nozzle is sized to be received by a transmission case inlet, and an internal diameter of the passage is less than a width of the tapered exit.

According to another embodiment of this disclosure, a transmission fluid fill system is disclosed. The fluid fill system may include a hollow shaft terminating at a tapered nozzle that has a single opening on a side thereof sandwiched between a dispersion plate and the shaft. The dispersion plate and an outer surface of the nozzle may define a tapered exit of the opening and the inner surface of the nozzle may define a non-tapered entrance of the opening, sized to be received by a transmission case inlet.

According to yet another embodiment of this disclosure, a method of filling a transmission is provided. The method may include inserting a transmission nozzle including a hollow shaft terminating at a tapered nozzle. The tapered nozzle may include a single opening on a side thereof sandwiched between a dispersion plate and the shaft. The dispersion plate and an outer surface of the nozzle may define a tapered exit of the opening and the dispersion plate and the inner surface of the nozzle may define a non-tapered entrance of the opening. The method may also include orienting the nozzle so that the single opening faces away from a wall of the transmission case and filling the transmission case with transmission fluid.

### BRIEF DESCRIPTION OF THE DRAWINGS

FIG. 1 is a pictorial view of a prior art transmission fluid nozzle.

FIG. 2 is a pictorial view of a transmission fluid nozzle.

FIG. 2A is a detailed pictorial view taken along the lines A-A.

FIG. 3 is a plan view of the transmission fluid nozzle.

FIG. 3A is a detail view of an end the transmission fluid nozzle.

FIG. 4 is a top view of the transmission fluid nozzle.

FIG. 5A is an image from a computer simulation of the transmission being filled with fluid by a previous nozzle.

FIG. 5B is an image from a computer simulation of the transmission being filled with fluid by a nozzle according to the present disclosure.

### DETAILED DESCRIPTION

Various embodiments of the present disclosure are described herein. However, the disclosed embodiments are merely exemplary and other embodiments may take various and alternative forms that are not explicitly illustrated or described. The figures are not necessarily to scale; some features may be exaggerated or minimized to show details of particular components. Therefore, specific structural and functional details disclosed herein are not to be interpreted as limiting, but merely as a representative basis for teaching one of ordinary skill in the art to variously employ the present invention. As those of ordinary skill in the art will understand, various features illustrated and described with reference to any one of the figures may be combined with features illustrated in one or more other figures to produce embodiments that are not explicitly illustrated or described. The combinations of features illustrated provide representative embodiments for typical applications. However, various combinations and modifications of the features consistent with the teachings of this disclosure may be desired for particular applications or implementations.

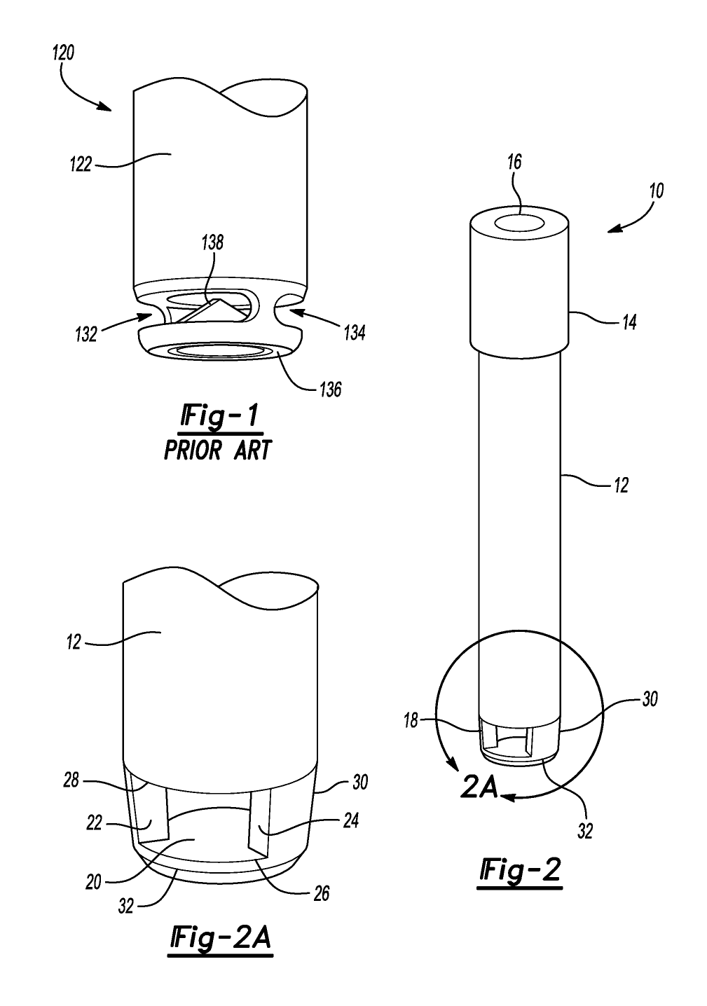

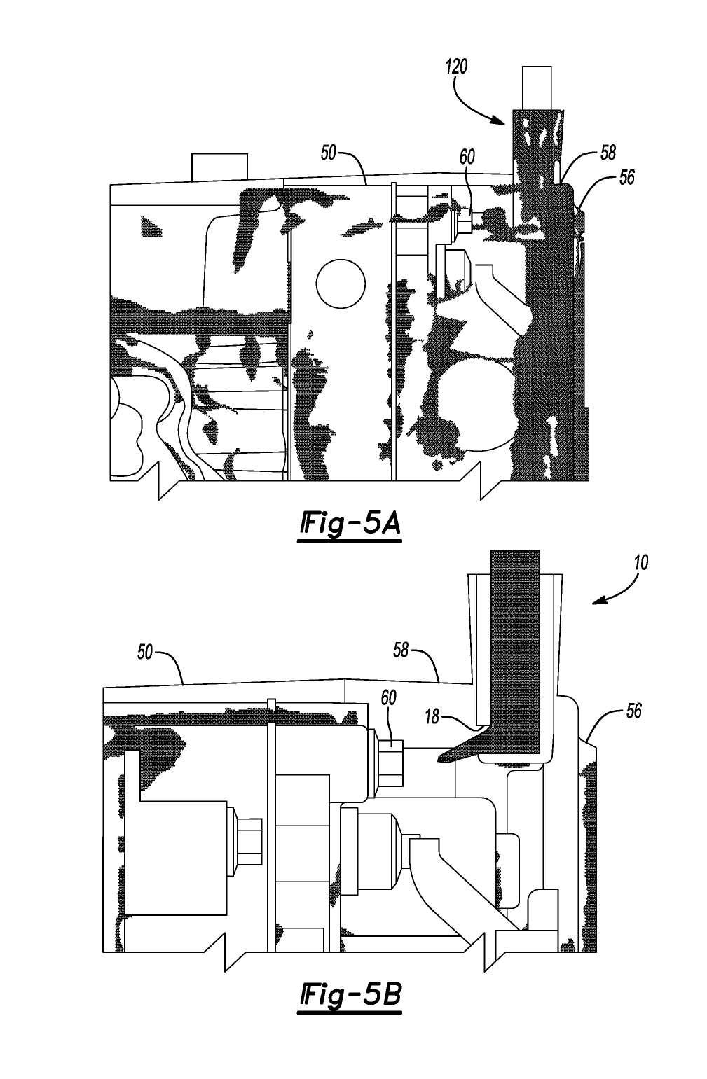

Referring to FIG. 1, a pictorial view of a prior art transmission nozzle 120 is illustrated. The nozzle 120 includes a shaft 122 that extends to two tapered openings 132 and 134. During operating the fluid would travel down a passage within the shaft 122 to a conical end plate 138. The conical end plate may alter the vertical component of the fluid into a horizontal component towards the two openings. The two openings 132 and 134 provide a flow of fluid that is distributed nearly 360°. As will be described in greater detail in FIG. 5A, it may be disadvantageous to distribute fluid around the entire circumference of the nozzle 120 when filling a transmission.

Referring to FIG. 2, a pictorial view of a transmission nozzle 10 according to one embodiment of this disclosure is illustrated. The nozzle 10 includes a shank 12 that extends from a collar 14. The distal end 30 opposite of the collar 16 may be tapered and include an output hole 18. The nozzle 10 may be made of steel, aluminum, magnesium, or any other suitable material. If the nozzle is made of metal, it may be formed by various processes, including but not limited to machining, casting, or additive manufacturing. In other embodiments, the nozzle may be comprised of plastic, such as thermoplastic, thermoset plastics, polymer, or any other suitable material. If the nozzle 10 is made of plastic, it may be formed by injection molding or any other suitable process. As will be described in greater detail below, the distal end may be referred to as a nozzle or a tapered nozzle. The tapered nozzle includes a single opening 18 that is spaced between the shaft 12 and a dispersion plate or tapered end 32.

Referring to FIG. 2A, a detailed pictorial view of a portion of the nozzle 10 is illustrated. The shaft 12 of the nozzle extends to the distal end 30. The distal end 30 may be round and tapered to insert the distal end of the nozzle into the transmission case filling hole (not shown) more easily. The distal end 30 may include an outlet hole or aperture 18. The outlet hole 18 may extend between the bottom edge 26 and the top edge 28. A first sidewall 22 and a second sidewall 24 extend between the bottom surface 20 and the top edge 28. A bottom surface or dispersion plate 20 defines the bottom edge of the opening and may have a relatively flat surface (±0.9 mm). The distal end 30 of the nozzle 10 may include a bottom tapered section 32.

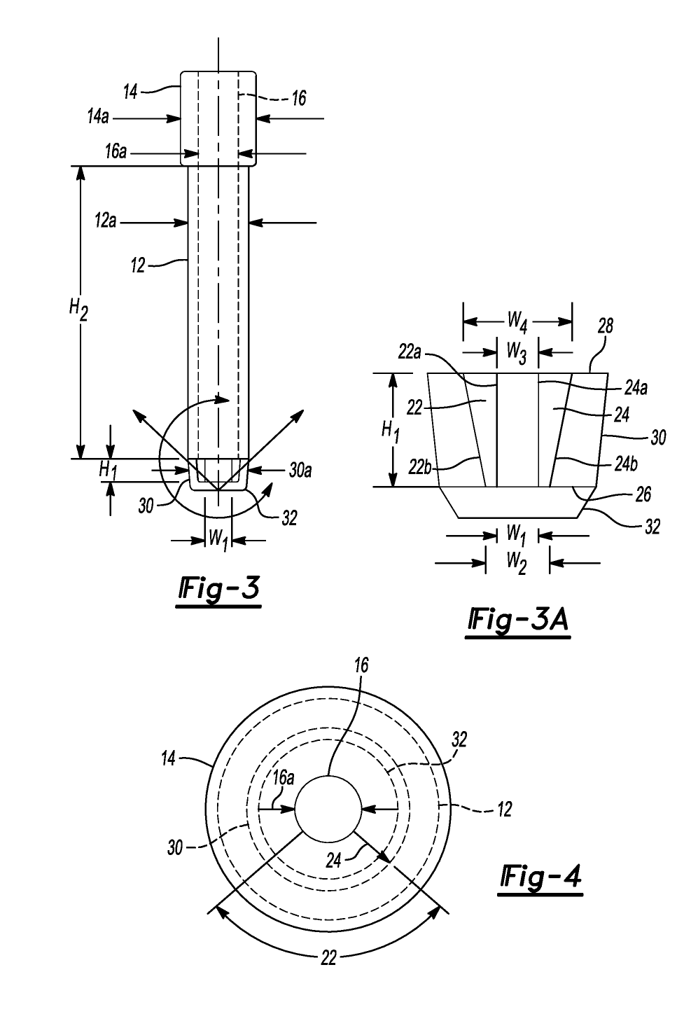

Referring to FIG. 3, a plan view of the nozzle assembly 10 is illustrated. As was already mentioned, the shank 12 extends between the collar 14 and the tapered end 30. The collar 14 may have an outer diameter 14a that is slightly larger than the shank 12a. The diameter 14a of the collar 14 may increase or decrease, depending on the mating hole or inlet of the transmission case (not shown). The collar 14 may rest against a raised portion of the transmission case and act as a stop to prevent the nozzle 10 from being inserted too far into the transmission case. The relative position of the collar 14 with respect to the opening may be selected for at least two purposes. First, as was already mentioned, the collar may rest on an external portion of the transmission case and act as a stop so the nozzle is not inserted too far within the transmission case. Second, the relative height H2 may control the flow rate of the fluid traveling through the shaft 12 and nozzle or distal end 30. Therefore, the height H2 may be inversely proportional to the height H₁. The distal end or nozzle 30 may be tapered and have a diameter 30a. A passage 16 extends from the top of the collar 14, through the shank 12, and terminates at the tapered distal end 30. In other embodiments, the passage 16 may extend through, or a portion thereof, the tapered distal and terminate at the outlet 18. The passage 16 may have a diameter 16a.

Referring to FIG. 3A a detailed view of a portion of the nozzle is illustrated. The view extends from the top edge 28 to a tapered bottom end 32 or dispersion plate. The dispersion plate 32 may redirect fluid that has a vertical component when moving along the passage 16. Once the fluid reaches the dispersion plate or tapered bottom end 32, it is redirected to move horizontally. All or most of the fluid will then travel through a non-tapered entrance, defined by walls 22a and 24a, of the opening 18 to a tapered exit, defined by walls 22b and 24b of the opening 18. The opening 18 defined by the distal end may have a height H₁. The bottom inner portion of the opening 18 may extend between the vertical walls 22a and 24a and have a width W₁. The bottom outer portion of the opening 18 may extend between the vertical walls 22b and 24b and have a width W₂. The top inner portion of the opening extends between the vertical walls 22a and 24a and has a width W₃. The top outer portion of the opening 18 may extend between the vertical walls 22b and 24b. The width W₂ may be larger than the width W₁. The width W₃ may be larger than the width W₁ but less than the width W₂. The width W₄ may be larger than the width W₃, W₂, and W₁. The height H₁ and the widths W₁, W₂, W₃, and W₄ may vary according to the required flow rate through the nozzle 10. The flow rate through the nozzle may depend on the volume and pressure of fluid entering the nozzle and the viscosity of the fluid among other factors.

Referring to FIG. 4, a top view of the nozzle 10 is illustrated. As was previously mentioned, the nozzle 10 has a collar 14 with an outer diameter 14a. The shank 12 is the next hidden line disposed near the collar 14 and has an outer diameter 12a. The tapered distal end 30 is the next hidden line positioned inwardly from line 12 and has an outer diameter 30a that may be less than the outer diameter 12a of the shank. The vertical walls 22 and 24 extend from the passage 16 to the tapered distal end 30. The passage 16 has a diameter 16a that may be less than the tapered bottom end 32. The vertical walls 22 and 24 may be angled relatively to one another as indicated by a. The angle may be approximately 90°. Approximately means within ±5°. The relative angle between the vertical walls 22 and 24 may facilitate the flow of oil into the case so that it is not sprayed against the wall of the case 50.

Referring to FIGS. 5A and 5B, two images from separate computer simulations of a fluid filling process is shown. Each image shows a portion of a transmission case 50 and an inlet port 58 that is defined by the case 50. Referring specifically to FIG. 5A, the transmission case 50 is being filled with a known nozzle 120 referenced in FIG. 1. As can be seen, the fluid exits the nozzle in nearly all directions. Because the prior art nozzle 120 in FIG. 5A sprays fluid towards and in close proximity to the wall 56 of the case 50, the oil begins to back up through a gap between the nozzle 120 and the case 50 then leak. Referring to FIG. 5B, the transmission case 50 is being filled with transmission fluid with the nozzle assembly 10 that was previously described. The nozzle assembly 10 is oriented in such a way that the opening 18 points away from the walls 56 of the transmission case 50. The opening 18 is positioned so that the fluid is directed towards the parking pawl 60 and other internal mechanisms within the transmission case. The orientation and specified geometry, as previously described, provides for a linear flow of fluid with minimum overflow or leaking.

The words used in the specification are words of description rather than limitation, and it is understood that various changes may be made without departing from the spirit and scope of the disclosure and claims. As previously described, the features of various embodiments may be combined to form further embodiments that may not be explicitly described or illustrated. While various embodiments may have been described as providing advantages or being preferred over other embodiments or prior art implementations with respect to one or more desired characteristics, those of ordinary skill in the art recognize that one or more features or characteristics may be compromised to achieve desired overall system attributes, which depend on the specific application and implementation. These attributes include, but are not limited to cost, strength, durability, life cycle cost, marketability, appearance, packaging, size, serviceability, weight, manufacturability, ease of assembly, etc. As such, embodiments described as less desirable than other embodiments or prior art implementations with respect to one or more characteristics are not outside the scope of the disclosure and may be desirable for particular applications.

What is claimed is:

1. An apparatus comprising:
an elongated shaft defining a passage terminating at a nozzle including a dispersion plate and tapered sidewalls sandwiched between the dispersion plate and the elongated shaft, wherein the tapered sidewalls define a single opening, an outer surface of the sidewalls define a tapered exit for the opening, an inner surface of the sidewalls define a non-tapered entrance into the opening, the nozzle is sized to be received by a transmission case inlet, and an internal diameter of the passage is less than a width of the tapered exit.

2. The apparatus of claim 1, wherein the passage of the elongated shaft defines an internal diameter that is greater than a width defined by the non-tapered entrance.

3. The apparatus of claim 1, wherein the non-tapered entrance is defined by first and second vertical walls that are arranged to define an angle that is less than or equal to 90°.

4. The apparatus of claim 1 further comprising a collar attached to an end of the elongated shaft opposite of the dispersion plate, wherein the collar is configured to act as a stop when the apparatus is inserted into a transmission case.

5. The apparatus of claim 4, wherein the single opening defines a first height and the collar is spaced apart from the single opening by a second height, and the first height is inversely proportional to the second height.

6. The apparatus of claim 5, wherein the internal diameter of the passage is less than the first height of the single opening.

7. The apparatus of claim 1, wherein the dispersion plate has a planar surface that is oriented towards the passage.

8. A transmission fluid fill system comprising:
a hollow shaft terminating at a tapered nozzle, that has a single opening on a side thereof sandwiched between a dispersion plate and the shaft, sized to be received by a transmission case inlet, the dispersion plate and an outer surface of the nozzle defining a tapered exit of the opening and the dispersion plate and an inner surface of the nozzle defining a non-tapered entrance of the opening.

9. The system of claim 8, wherein the non-tapered entrance is defined by first and second vertical walls that are arranged to define an angle that is less than or equal to 90°.

10. The system of claim 8, wherein the hollow shaft defines a center axis extending along a length of the shaft, the opening is defined by a first vertical wall disposed along a first plane and a second vertical wall disposed along a second plane, and the first plane and second plane are oriented to intersect at the center axis.

11. The system of claim 8, further comprising a collar attached to an end of the hollow shaft opposite the tapered nozzle and spaced apart from the opening by a predetermined distance such that the collar acts as a stop when the nozzle is inserted into the transmission case inlet.

12. The system of claim 11, wherein the predetermined distance is inversely proportional to a height of the single opening.

13. The system of claim 8, wherein the hollow shaft defines an internal diameter that is greater than a width defined by the non-tapered entrance.

14. The system of claim 13, wherein the internal diameter of the hollow shaft is less than a width defined by the tapered exit.

15. The system of claim 8, wherein the single opening of the nozzle is configured to disperse fluid away from a wall of a transmission case and towards a parking pawl mechanism.

16. The system of claim 15, wherein an internal diameter of the hollow shaft defines a first cross-sectional area and the non-tapered entrance defines a second cross-sectional area that is at least 15% less than the first cross-sectional area such that air may escape through the hollow shaft as fluid is dispersed through the non-tapered entrance.

17. The nozzle of claim 8, wherein the tapered nozzle and the single opening define a first vertical wall and a second vertical wall each having an inner edge and an outer edge, the outer edge is spaced further away from a center of the shaft than the inner edge, the inner edge of the first vertical wall and a bottom surface defines a first connecting point, the outer edge of the first vertical wall and the bottom surface defines a second connecting point, the inner edge of the second vertical wall and the bottom surface defines a third connecting point, the outer edge of one of the vertical walls and the bottom surface defines a fourth connecting point, the first connecting point and the third connecting point are spaced apart by a first width, and the third connecting point and the fourth connecting point are spaced apart by a second width that is greater than the first width.

18. A method of filling a transmission comprising:
inserting a transmission nozzle including a hollow shaft terminating at a tapered nozzle that has a single opening on a side thereof sandwiched between a dispersion plate and the shaft, the dispersion plate and an outer surface of the nozzle defining a tapered exit of the opening and the dispersion plate and an inner surface of the nozzle defining a non-tapered entrance of the opening;
orienting the nozzle so that the single opening faces away from a wall of a transmission case; and
filling the transmission case with transmission fluid.
